(19) United States
(12) Patent Application Publication
(10) Pub. No.: US 2008/0267082 A1
(43) Pub. Date: Oct. 30, 2008

(54) Signaling Monitoring System, Signaling Network And Signaling Monitoring Method

(75) Inventor: Yubin Li, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/167,868

(22) Filed: Jul. 3, 2008

Related U.S. Application Data
(63) Continuation of application No. PCT/CN07/00028, filed on Jan. 5, 2007.

(30) Foreign Application Priority Data
Jan. 6, 2006 (CN) 200610000056.2

(51) Int. Cl. H04L 12/26

(52) U.S. Cl. 370/249

(57) ABSTRACT

A signaling monitoring system includes a signaling network node device having an IP interface, a signaling network monitoring device having an IP interface and an network, in which the signaling network node device and the signaling network monitoring device are connected to the IP network via the IP interface, respectively; the signaling network node device sends signaling messages to the signaling network monitoring device via the IP network; the signaling network monitoring device analyzes the received signaling messages and obtains the monitoring information. The disclosure also discloses a signaling network and a signaling network monitoring method. While the monitoring function is implemented, the transmission resource is saved.

### CROSS-REFERENCE TO RELATED APPLICATIONS

This application is a continuation of International Application No. PCT/CN2007/000028, Filed Jan. 5, 2007. This application claims the benefit of Chinese Application No. 200610000056.2, filed Jan. 6, 2006. The disclosures of the above applications are incorporated herein by reference.

### FIELD

The present invention relates to communication technologies and to signaling monitoring technologies.

### BACKGROUND

Signaling networks, as important components of modern communication networks, are mainly used for transmission of signaling messages. In order to monitor traffic operations, signaling network monitoring devices are configured in signaling networks for monitoring all signaling messages sent from or to signaling network node devices, and analyzing the monitored signaling messages. Messages related to Call services, etc., are extracted through analyses on the signaling messages, so that the running status of equipments and the distribution of services in the signaling networks can be obtained, thereby enhancing maintenance of the signaling network. At present, domestic large operators have built or are building signaling monitoring systems covering backbone signaling networks, and thus signaling networks can be monitored.

Taking No. 7 signaling networks as example, most of the No. 7 signaling networks are carried by E1 which is a link encoded with Pulse Code Modulation (PCM) and having a bandwidth of 2.048 M. E1 links may be used to connect closely-located signaling node devices directly, while auxiliary transmission devices are required to connect remotely-located signaling node devices. As shown in FIG. 1, the signaling network node devices 1, 2 and 3 are connected to respective transmission devices via an E1 link, and the transmission devices are connected with each other through high speed transmission media such as optical fibers. In order to monitor service running in the signaling network shown in FIG. 1, a signaling network monitoring device is provided as shown in FIG. 1. The signaling monitoring systems presently constructed are all based on Time Division Multiplex (TDM) mode. As shown in FIG. 1, through physical connections of an E1 link in a Digital Distribution Frame (DDF), a signaling message received from or sent to a port of the DDF frame is mapped to another port, and then sent from the mapped port to the signaling monitoring system consisting of a signaling network monitoring device and an E1 link, and thus the monitoring can be achieved. The DDF frame is suitable to be used between digital multiplex devices having a bandwidth ranging from 2 to 155 Mbit/s, and can provide wiring connection between a digital multiplex device and a Private Branch Exchange (PBX) device or a non-voice service device, providing the functions of dispatching, transferring and monitoring digital signals of a circuit group.

However, if signaling messages are transmitted between a DDF frame and a signaling monitoring system through an E1 link, an E1 cable is required to connect the DDF frame and the signaling monitoring system. In view of the hardware connections in present machine rooms, the E1 cable between the DDF frame and the signaling monitoring system will be relatively long, and the cost of the E1 cable is relatively high. In addition, signaling messages carried by E1 cables exclusively occupy bandwidth resources, resulting in waste of bandwidth resources. Therefore, the signaling monitoring systems currently constructed consume too much transmission resources.

### SUMMARY

In view of the above disadvantages in the prior art, one of many objects of the present invention is to provide a signaling monitoring system, a signaling network and a signaling monitoring method, so as to save transmission resources while signaling monitoring is performed.

To achieve various objects of the present invention, an embodiment provides a signaling monitoring system. The system includes a signaling network node device having IP interfaces, a signaling network monitoring device having IP interfaces, and an IP network. The signaling network node device and the signaling network monitoring device are accessed to the IP network via their IP interfaces respectively. The signaling network node device is adapted to send a signaling message to the signaling network monitoring device via the IP network, and the signaling network monitoring device is adapted to analyze the received signaling message to obtain monitoring information.

An embodiment of the present invention further provides a signaling network. The signaling network includes: at least two signaling network node devices having IP interfaces, at least two transmission devices, a transmission network, a signaling network monitoring device having IP interfaces, and an IP network; wherein, the at least two signaling network node devices are connected with the transmission devices respectively; the at least transmission devices are connected with each other via the transmission network; the signaling network node devices and the signaling network monitoring device are accessed to the IP network via their IP interfaces respectively; the signaling network node devices are adapted to send a signaling message to the signaling network monitoring device via the IP network, and the signaling network monitoring device is adapted to analyze the received signaling message to obtain monitoring information.

An embodiment of the present invention further provides a signaling monitoring method. The method includes: a signaling network node device having an IP interface sends a signaling message to a signaling network monitoring device having an IP interface via an IP network, and the signaling network monitoring device analyzes the received signaling message to obtain monitoring information.

In the embodiments of the present invention, a signaling network node device is connected with a signaling network monitoring device through a technically matured IP network, so as to achieve signaling monitoring function. Firstly, generally, an IP network can be easily accessed from the machine room where a signaling network node device is placed; secondly, since the signaling network node device is close to the IP network, the network cable that connects the signaling network node device to the IP network is short, and the cost of the network cable is relatively low; thirdly, the signaling message carried by the IP network may share bandwidths, and thus less resources are consumed. Therefore, in the embodiments of the present invention, transmission resources can be saved while monitoring function is achieved.

### DRAWINGS

FIG. 1 is a structural schematic diagram of a signaling network in the prior art;

FIG. 2 is a structural schematic diagram of a signaling network according to an embodiment of the present invention;

FIG. 3 is a format of a message packet in an embodiment of the present invention;

FIG. 4 is a format of a handshake message in an embodiment of the present invention;

FIG. 5 is a flowchart of an embodiment of the prevent invention;

FIG. 6 is a flowchart of another embodiment of the present invention.

### DETAILED DESCRIPTION

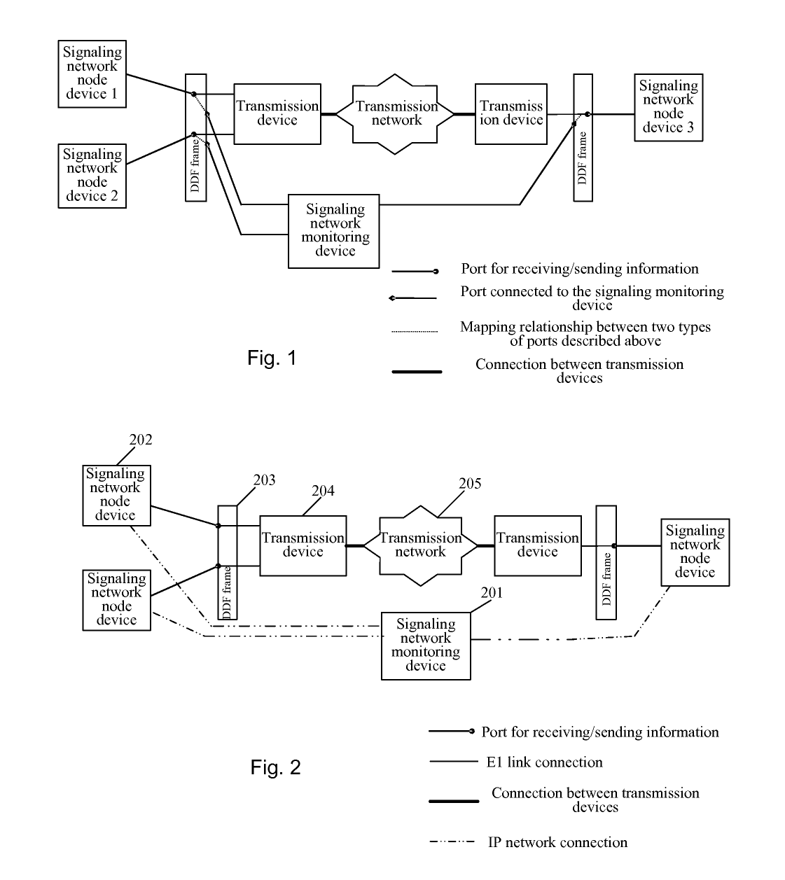

With reference to FIG. 2, a signaling monitoring system according to an embodiment of the present invention is described. As shown in FIG. 2, the signaling monitoring system includes: a signaling network monitoring device 201, a plurality of signaling network node devices 202, and an IP network. The signaling network node devices 202 may be devices having Signaling Transfer Point (STP) or Signaling Point (SP) function in a signaling network. The signaling network monitoring device 201 and the plurality of signaling network node devices 202 each have at least one IP interface, and are accessed to the IP network via IP interfaces respectively. The dashed line in FIG. 2 represents that the signaling network monitoring device 201 is connected with the signaling network node devices 202 in an IP network connection mode. The signaling network monitoring device 201 may also be accessed to the IP network via network routing devices, and in such a case, the signaling network monitoring device 201, the plurality of signaling network node devices 202 and the IP network constitute a signaling monitoring system carried by an IP network. Currently, the IP network has been maturely constructed, and the signaling network node devices 202 can easily be connected to the IP network via network cables. Because the signaling network node devices 202 are close to the IP network, the network cables used to connect the signaling network node devices 202 and the IP network are not too long, and because the cost of network cables is lower than that of E1 cables, the transmission resources can be saved when the IP network bears the function of signaling monitoring. In addition, signaling messages carried by the IP network may share bandwidths, and thus the transmission resources can be further saved.

The signaling network node device 202 can send signaling messages to the signaling network monitoring device 201 via the IP network. The signaling messages may be signaling messages related to call services, etc. The signaling network node device 202 can check received and sent signaling messages, duplicate signaling messages related to call services, etc, and send the duplicated signaling messages to the signaling network monitoring device 201 via the IP network. After checking the received and sent signaling messages, the signaling network node device 202 may further modify or re-edit the signaling messages related to call services, etc, and send the modified or edited signaling messages to the signaling network monitoring device 201 via the IP network. In general, the signaling messages are standard messages, i.e., the signaling message can be recognized by function entities in the monitoring system or the entire signaling network. If the signaling network node device 202 only duplicates the signaling messages related to call services, etc, and sends the duplicated signaling messages to the signaling network monitoring device 201 via the IP network, the duplicated signaling messages can be recognized by the function entities in the monitoring system or the entire signaling network.

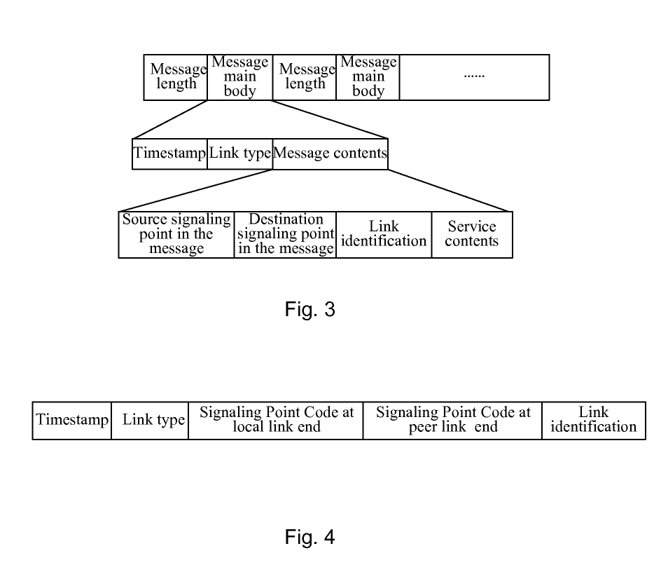

If the signaling network node device 202 sends a plurality of signaling messages to the signaling network monitoring device 201, the plurality of signaling messages may be compressed into a message packet and sent to the signaling network monitoring device 201. In this way, the transmission resource can be further saved as well as the transmission efficiency of the signaling message can be improved. FIG. 3 shows a format of a message packet. A message packet may include a message length and a message main body. The message main body may include a timestamp, a link type and message contents; the message contents may include information on source signaling network node device 201 in the message, information on destination signaling network node device 202 in the message, a link identification and service contents.

The signaling network monitoring device 201 may analyze the received signaling messages to obtain monitoring information. The analyzing may be a real-time analyzing and/or a subsequent analyzing. After the analyzing, the signaling network monitoring device 201 can obtain the monitoring information. The monitoring information may include at least one of the following:

Calling user information; called user information;

Call Length;

Related signaling network node information;

Reason for call failure.

In addition, the signaling network node device 202 may further send a handshake message to the signaling network monitoring device 201 via the IP network. A handshake message may be actively and periodically sent by the signaling network node device 202 to the signaling network monitoring device 201. The handshake message is a message generated by the signaling network node device 202. If the signaling network node device 202 sends the handshake message to the signaling network monitoring device 201, in the entire monitoring system, or even in the entire monitoring network, this handshake message can be recognized only by the signaling network node device 202 that sends the handshake message and the signaling network monitoring device 201 that receives the handshake message. A format of the handshake message is shown in FIG. 4. The handshake message includes a timestamp, a link type, a Signaling Point Code at the local link end, a Signaling Point Code at the peer link end, and a link identification.

The signaling network node device 202 may send a signaling message and/or a handshake message to the signaling network monitoring device 201 via IP network directly, or via a network route device in the IP network.

The signaling network monitoring device 201 analyzes the received handshake message, so as to obtain monitoring information. The analyzing may be a real-time analyzing and/or a subsequent analyzing. After the analyzing, the signaling network monitoring device 201 can obtain the monitoring information. The monitoring information may include at least one of the following:

information on main nodes related to call services in the signaling network;

connection mode in which all the signaling network node devices and the main nodes are connected, including broadband connection mode and narrowband connection mode;

connection status between all the main nodes;

signaling network topological view; and etc.

The signaling network monitoring device 201 is capable of obtaining the network topological view through handshaking with the signaling network node device 202.

Further, the signaling messages received and sent by the signaling network node device 202 may be converted into customized IP messages that are customized between the signaling network monitoring device 201 and the signaling network node device 202, and sent to the signaling network monitoring device 201.

The signaling network monitoring device 201 can provide information such as call analysis and network status after analyzing the received messages.

The signaling monitoring system may be applied to a signaling network, and a signaling network is further provided according to an embodiment of the present invention. With reference to FIG. 2 again, the signaling network includes: a signaling network node device 202, a DDF frame 203, a transmission device 204 and a transmission network 205. The signaling network node device 202 is connected to the transmission devices 204 via the DDF frame 203, and the transmission devices 204 are connected with each other through the transmission network 205. El cables are used to connect the signaling network node device 202 and the DDF frames 203, and to connect the DDF frames 203 and the transmission devices 204. The transmission device 204 may be connected to the transmission network via a transmission cable, and the transmission cable may be an optical fiber cable. The transmission devices 204 may also be connected with each other via microwave. The signaling network further includes: a signaling network monitoring device 201, a plurality of signaling network node devices 202 and an IP network. The signaling network node device 202 may be a device having STP or SP function in a signal network. The signaling network monitoring device 201 and the plurality of signaling network node device 202 each have at least one IP interface, and are accessed to the IP network via respective IP interfaces. The dashed line in FIG. 2 represents that the signaling network monitoring device 201 is connected with the signaling network node devices 202 in the IP network connection mode. Thus, the signaling network monitoring device 201, the signaling network node devices 202 and the IP network constitute a signaling monitoring system carried by the IP network. In FIG. 2, signaling network node devices 202 are connected to the transmission device 204 via the DDF frame 203. Practically, however, signaling network node devices 202 may also be connected to the transmission device 204 via the IP network. According to an embodiment of the signaling network, the signaling network node device 202 and the transmission device 204 both have IP interfaces, and are accessed to the IP network via respective IP interfaces, thus, the signaling network node devices 202 may be connected with the transmission device 204 via the IP network.

In FIG. 2, the transmission devices 204 are connected with each other through the transmission network 205. Practically the transmission devices 204 may also be connected with each other through an IP network. According to an embodiment of the signaling network, all the transmission devices 204 have IP interfaces, and are accessed to an IP network via respective IP interfaces, thus, the transmission devices 204 may be connected with each other via the IP network.

In FIG. 2, the signaling network node device 202 can be connected with the transmission devices 204 via an IP network, and the transmission devices 204 can be connected with each other via an IP network.

An embodiment of the present invention further provides a signaling monitoring method. The signaling monitoring method may be applied in a signaling network and the signaling network includes signaling network node devices and a signaling network monitoring device.

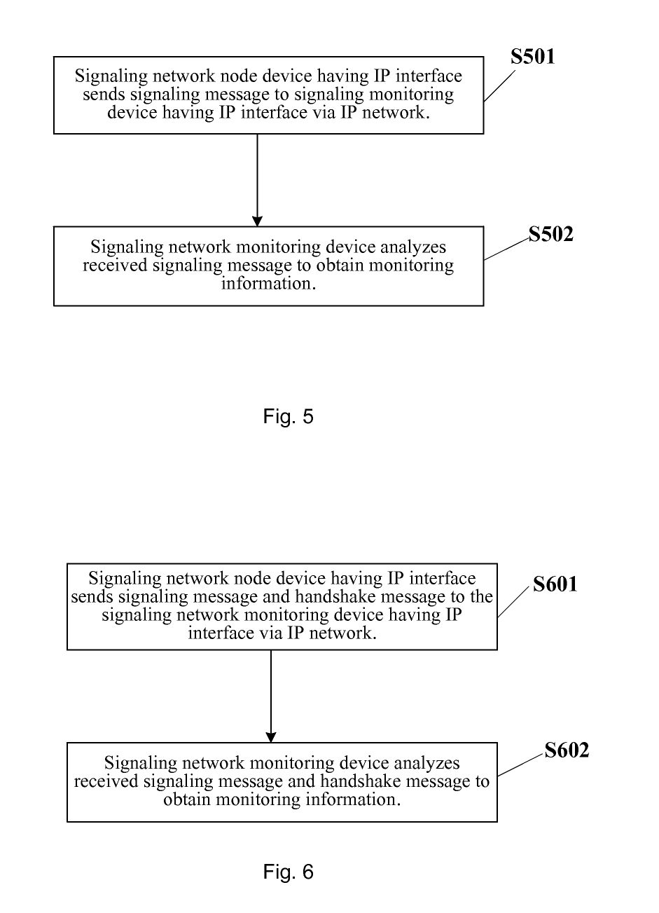

FIG. 5 shows a flowchart of a method according to an embodiment of the present invention. As shown in FIG. 5, the method includes:

Step S501: A signaling network node device having an IP interface sends a signaling message to a signaling network monitoring device having an IP interface via an IP network.

The signaling network node device may be a device having STP or SP function in a signaling network. The signaling network monitoring device and the signaling network node device each have at least one IP interface, and are accessed to an IP network via respective IP interface, thus, the signaling network monitoring device, the signaling network node device and the IP network constitute a signaling monitoring system carried by an IP network. Currently, the IP network has been maturely constructed, and the signaling network node device can easily be connected to the IP network via a network cable, and because the signaling network node device is close to the IP network, the network cable used to connect the signaling network node device and the IP network is not too long; and because the cost of network cables is lower than that of E1 cables, the transmission resources can be saved when the IP network bears the function of signaling monitoring. Furthermore, signaling messages carried by the IP network may share bandwidths; therefore the transmission resources can be further saved.

The signaling message sent by the signaling network node device may be a signaling message related to call services and etc. The signaling network node device may check the received and sent signaling messages, duplicate the signaling messages related to call services and etc, and send the duplicated signaling messages to the signaling network monitoring device via the IP network. After checking the received and sent signaling messages, the signaling network node device may modify or re-edit the signaling messages related to call services and etc, and send the modified or edited signaling messages to the signaling network monitoring device via the IP network. In general, signaling messages are standard messages, i.e., the signaling message can be recognized by all the function entities in the monitoring system or the entire signaling network. If the signaling network node device only duplicates the signaling messages related to call services and etc, and sends the duplicated signaling messages to the signaling network monitoring device via the IP network, the duplicated signaling messages can be recognized by all the function entities in the monitoring system or the entire signaling network.

If the signaling network node device sends a plurality of signaling messages to the signaling network monitoring device, the plurality of signaling messages may be compressed into a message packet, and sent to the signaling network monitoring device. In this way, not only the transmission efficiency of the signaling message can be improved, but also the transmission resources can be further saved. FIG. 3 shows a format of a message packet. The message packet may include a message length and a message main body. The message main body may include a timestamp, a link type and message contents; the message contents may include source signaling network node device information in the message, destination signaling network node device information in the message, a link identification and service contents.

Step S502: The signaling network monitoring device analyzes the received signaling message to obtain monitoring information.

The mode in which the signaling network monitoring device analyzes the received signaling message may be real-time analyzing and/or subsequent analyzing. After the analyzing, the signaling network monitoring device can obtain monitoring information. The monitoring information may include at least one of the following:

Calling user information;

Called user information;

Call Length;

Related signaling network node device;

Reason for call failure.

In addition, the signaling network node device may further send a handshake message to the signaling network monitoring device 201 via the IP network. With reference to FIG. 6, a method according to another embodiment of the present invention is described. As shown in FIG. 6, the method according to an embodiment includes:

Step S601: The signaling network node device having an IP interface sends a signaling message and a handshake message to the signaling network monitoring device having an IP interface via the IP network.

The process of sending a signaling message from the signaling network node device to the signaling network monitoring device is the same as Step S501 in FIG. 5. The signaling network node device may actively and periodically send a handshake message to the signaling network monitoring device. The handshake message is a message generated by the signaling network node device. If the signaling network node device sends the handshake message to the signaling network monitoring device, in the entire monitoring system, or even in the entire monitoring network, this handshake message can be recognized only by the signaling network node device that sends the handshake message and the signaling network monitoring device that receives the handshake message. A format of the handshake message is shown in FIG. 4. The handshake message includes a timestamp, a link type, a Signaling Point Code at the local link end, a Signaling Point Code at the peer link end, and a link identification.

The signaling network node device may send a signaling message and/or a handshake message to the signaling network monitoring device via IP network directly, or via a network routing device in the IP network.

Step S602: The signaling network monitoring device analyzes the received signaling message and the handshake message to obtain monitoring information.

The process of analyzing the received signaling message by the signaling network monitoring device is the same as Step S502 in FIG. 5. The mode in which the signaling network monitoring device analyzes the received handshake message may be real-time analyzing and/or subsequent analyzing. After the analyzing, the signaling network monitoring device can obtain monitoring information. The monitoring information may include at least one of the following:

information on main nodes related to call services in the signaling network;

connection mode between all the signaling network node devices and the main nodes, including broadband connection mode and narrowband connection mode;

connection status between all the main nodes;

signaling network topological view, and etc.

The signaling network monitoring device is capable of obtaining network topological view through handshaking with the signaling network node device.

Further, the signaling messages received and sent by the signaling network node device may be converted into customized IP messages that are customized between the signaling network monitoring device and the signaling network node device, and sent to the signaling network monitoring device.

The signaling network monitoring device can provide information such as call analyses and network status after analyzing the received messages.

In an embodiment of the present invention, the technically matured IP network is used to connect a signaling network node device and a signaling network monitoring device to bear signaling monitoring. Firstly, in general, the IP network can be easily accessed from a machine room where the signaling network node device is placed; secondly, since the signaling network node device is close to the IP network, the network cable that connects the signaling network node device to the IP network is short, and the cost of network cables is relatively low; thirdly, the signaling message carried by the IP network may share bandwidths, and therefore less resources are consumed. Therefore, according to the embodiments of the present invention, transmission resources can be saved while the monitoring function is realized.

In an embodiment of the present invention, if the signaling network node device sends a plurality of signaling messages, the plurality of signaling messages may be compressed into a message packet, and sent to the signaling network monitoring device. In this way, not only the transmission efficiency of the signaling message can be improved, but also the transmission resources can be further saved.

In an embodiment of the present invention, the signaling network node device may duplicate the signaling messages related to call services and etc, and also may modify or re-edit the signaling messages related to call services and etc. Thus, the signaling network node device may select more flexibly information to be sent to the signaling monitoring device, and the signaling network monitoring device may obtain more accurate monitoring information through the modified or re-edited messages.

In an embodiment of the present invention, the signaling network node device may send not only signaling messages, but also handshake messages generated actively by the signaling network node device, to the signaling network monitoring device. Through such a handshake mode, the signaling network monitoring device is capable of obtaining the network topological view of the signaling network, and thereby more accurately grasps information such as running status of the signaling network.

In an embodiment of the present invention, the signaling network node devices may be connected with the transmission devices via the IP network, and the transmission devices may be connected with each other via the IP network. Since the bandwidths are shared in the IP network, the transmission resources used for signaling transmission can be saved.

The illustrative embodiments of the present invention are described as above, but it should be appreciated that the scope claimed by the present disclosure is not limited to the above embodiments. Any modification or replacement within the technical scope disclosed in the present disclosure that can be easily thought of by the ordinary skilled in the art should be covered within the scope of the present disclosure.

What is claimed is:

1. A signaling monitoring system, comprising:
a signaling network node device having at least one IP interface, a signaling network monitoring device having at least one IP interface, and an IP network, the signaling network node device and the signaling network monitoring device being accessed to the IP network via their respective IP interfaces; wherein the signaling network node device is adapted to send a signaling message to the signaling network monitoring device via the IP network, and the signaling network monitoring device is adapted to analyze the signaling message to obtain monitoring information.

2. The signaling monitoring system as claimed in claim 1, wherein, if the signaling network node device sends a plurality of signaling messages to the signaling network monitoring device, the plurality of signaling messages are compressed into a message packet which is sent to the signaling network monitoring device.

3. The signaling monitoring system as claimed in claim 2, wherein, the message packet comprises: a message length and a message main body, wherein, the message main body comprises a timestamp, a link type and message contents; the message contents comprise source signaling network node device information in the message, destination signaling network node device information in the message, a link identification and service contents.

4. The signaling monitoring system as claimed in any one of claim 1, wherein, the monitoring information comprises at least one of:
calling user information;
called user information;
call length;
related signaling network node device; or
reason for call failure.

5. The signaling monitoring system as claimed in claim 1, wherein, the signaling network node device is adapted to further sends a handshake message to the signaling monitoring device via the IP network.

6. The signaling monitoring system as claimed in claim 5, wherein, the handshake message comprises at least one of: a timestamp, a link type, a Signaling Point Code at the local link end, a Signaling Point Code at the peer link end, or a link identification.

7. The signaling monitoring system as claimed in claim 5, wherein, the signaling network monitoring device is adapted to analyze the handshake message to obtain monitoring information.

8. The signaling monitoring system as claimed in claim 7, wherein, the monitoring information comprises at least one of:
information on main nodes related to call services in a signaling network;
connection mode in which all the signaling network node devices and the main nodes are connected;
connection status between all the main nodes; or
signaling network topological view.

9. The signaling monitoring system as claimed in claim 5, wherein, the signaling network node device is adapted to further send the handshake messages to the signaling monitoring device actively and periodically.

10. A signaling network, comprising: a plurality of signaling network node devices each having at least one IP interface, a plurality of transmission devices, a transmission network, a signaling network monitoring device having at least one IP interface, and an IP network; wherein, the plurality of signaling network node devices are connected with the transmission devices respectively; the plurality of transmission devices are connected with each other via the transmission network; the signaling network node devices and the signaling network monitoring device are accessed to the IP network via their respective IP interfaces; the signaling network node devices are adapted to send a signaling message to the signaling network monitoring device via the IP network, and the signaling network monitoring device adapted to analyze the signaling message to obtain monitoring information.

11. The signaling network as claimed in claim 10, further comprising a plurality of DDF frames.

12. The signaling network as claimed in claim 11, wherein, the plurality of signaling network node devices are connected to the transmission devices via the DDF frames respectively.

13. The signaling network as claimed in claim 10, wherein, the plurality of signaling network node devices are connected to the transmission devices via the IP network or an E1 cable respectively.

14. The signaling network as claimed in claim 1, wherein, the signaling network node device is adapted to send a signaling message related to call services to the signaling network monitoring device via the IP network.

15. A signaling monitoring method, comprising:
sending, by a signaling network node device having at least one IP interface, a signaling message to a signaling network monitoring device having at least one IP interface via an IP network; and
analyzing, by the signaling network monitoring device, the received signaling message to obtain monitoring information.

16. The signaling monitoring method as claimed in claim 15, wherein, if the signaling network node device sends a plurality of signaling messages to the signaling network monitoring device, the plurality of signaling messages are compressed into a message packet which is sent to the signaling network monitoring device.

17. The signaling monitoring method as claimed in claim 15, further comprising: sending, by the signaling network node device, a handshake message to the signaling monitoring device via the IP network.

18. The signaling monitoring method as claimed in claim 17, further comprising: analyzing, by the signaling network monitoring device, the received handshake message to obtain monitoring information.

19. The signaling monitoring method as claimed in claim 15, wherein, the analyzing includes real-time analyzing and/or subsequent analyzing.

20. The signaling monitoring system as claimed in claim 6, wherein, the signaling network monitoring device is adapted to analyze the handshake message to obtain monitoring information.
